(19) United States
(12) Patent Application Publication
(10) Pub. No.: US 2007/0113605 A1
(43) Pub. Date: May 24, 2007

(54) Magnetically controlled locking device

(76) Inventor: Jesus Lopez, Saint-Beauzire (FR)

Correspondence Address: Ralph A. Dowell of DOWELL & DOWELL P.C., 2111 Eisenhower Ave, Suite 406, Alexandria, VA, 22314, US

(21) Appl. No.: 10/544,529

(22) PCT Filed: Feb. 17, 2003
(86) PCT No.: PCT/FR03/00511

§ 371 Date: Jun. 7, 2006

(51) Int. Cl. E05B 47/00

(52) U.S. Cl. 70/276

(57) ABSTRACT

The device comprises a stator (14) and a rotor (9) rotated by a key (8). The latter comprises several bushings (10c) which clasp the magnets (10c) and attract or repel magnets (10b₁, 10b₂) having a complementary or identical polarity and which are disposed inside the bushings (10b) such that they move inside the housings (17) of the rotor (9). In order to maintain the angular position thereof and to facilitate translatory guidance, the bushings (20b) comprise a rotational locking element (22) which engages into a groove (23) of the corresponding housing (17). In order to increase the number of combinations, each bushing (10b) of the rotor (9) or key (8) houses two magnets (10₁, 10b₂) having inverted polarity or a magnet provided with at least one bipolar extremity, which are adapted in such a way that they can occupy different angular positions about a longitudinal axis (BB′) of the bushing (10b, 10c). Such a device, by virtue of the precision of the relative movements of the axis and the high number of possible combinations, makes it possible to increase the inviolability of a locking device designed to prevent access to an opening.

The invention relates to an improved magnetically controlled locking device.

European Patent Application EP-A-633 375 discloses a magnetically controlled locking device comprising a key and a cylinder. This cylinder comprises a stator and a rotor, the latter being set in rotation about a longitudinal axis of the cylinder by the key. The cylinder bears a plurality of magnets oriented in a direction globally parallel to the axis of rotation of the rotor. These magnets cooperate with other magnets distributed opposite in a part of the key. These magnets are clasped in bushings made of ferromagnetic metal. The bushings bearing the magnets located in the cylinder are mobile in translation inside housings of complementary shape.

When that part of the key bearing the magnets is presented opposite the magnets of the corresponding part of the rotor, these latter attract or repel depending on the polarities and respective positions of the magnets borne by the key and the cylinder. In this way, the key induces the displacement, towards the bottom of the corresponding housing or in the direction of the opening of this housing, of the bushings located in the cylinder. Such displacement has for consequence respectively to unlock the rotor and to allow its rotation or to block it in rotation. The rotor is associated with a member, for example an eccentric mounted on its rotational spindle, which may displace a slide block which actuates a bolt in a keeper.

When the magnetic axes of two magnets, borne by the cylinder and by the key, merge and depending on whether their extremities opposite each other form identical or inverted magnetic poles, they repel or attract each other. On the other hand, if the magnetic axes of these magnets are slightly offset, i.e. if the longitudinal axes of the magnets are parallel and/or non-merged, the extremities of the magnets opposite each other and of identical magnetic poles, do not repel but attract each other. This is due to the fact that the magnets are clasped in ferromagnetic bushings which channel the magnetic flux and behave, in a zone of their wall and in contact with a pole of the magnet clasped in the bushing, like a magnetic pole inverse of the pole of the magnet.

In this way, by playing on the number of magnets, their polarities and their relative positions, a plurality of associations between the magnetic poles of the magnets of the key and of the cylinder are very easily obtained. The magnets thus attract or repel depending on their implantation, while allowing a coding of the locking device. With such a device, the contact of the respective extremities of the magnets of the cylinder and of the key is effected thanks to the adjacency of terminal parts of the rotor and of the key. These terminal parts are planar metal pieces provided with a simple device for guiding and positioning the key opposite the rotor, for example one or more studs penetrating in one or more impressions.

One of the principal difficulties of such a devices resides in the limited number of combinations enabling devices to be produced which can be maneuvered by general or partial pass-keys or in varied structures.

Furthermore, if it is desired to increase the possibilities of combinations between the magnets of the key and of the cylinder for a given matrix, and thus increase the potential number of devices in operation while preserving a unique coding for each, it is indispensable to be able to play on the number and the magnetic moment of the magnets employed in the device.

Now, for practical and economic reasons, it is not desirable to increase unduly the size of the device, and particularly that of the key, in order to house more magnets.

It is a more particular object of the invention to overcome these drawbacks by proposing a magnetically controlled locking device presenting an increased inviolability and of which the positioning of the bushings bearing the magnets is precise and reliable, while allowing a number of combinations greater than that of the known device.

To that end, the invention has for its object a magnetically controlled locking device comprising a cylinder provided with a stator and a rotor, the rotor being adapted to be rotated about a longitudinal axis of the cylinder thanks to a key, the latter being equipped with magnets clasped in bushings made of ferromagnetic material and adapted to cooperate with other magnets likewise clasped in bushings made of ferromagnetic material, mounted to slide in at least a part of the cylinder so as to be able selectively to lock the rotation of the rotor, these magnets, respectively borne by the key and the cylinder, being of the same geographical distribution, characterized in that at least two bushings located respectively in the key and the cylinder each clasp and maintain two magnets of inverted polarity with respect to each other or a magnet provided with at least one bipolar extremity.

Thanks to the invention, a device is produced where the presence of two magnets of inverted polarity, or of one magnet provided with at least one bipolar extremity, per bushing makes it possible to multiply the number of combinations possible, all the more so as one can play on the various relative angular positions of the magnets between them. By maintaining the angular position, the relative positioning of the magnets of the cylinder and the key is ensured precisely and constantly in time. The precision of the “geographical” register between the magnetic bushings borne by the rotor and those borne by the key is optimized. In effect, a slight angular or radial displacement of a magnet may modify the value of reception of the magnetic fluxes between the magnets of the rotor and the key, and even invert the direction of the magnetic flux. This angular or radial deviation may go as far as preventing the displacement of the bushing of the cylinder in translation. This has for consequence a blocking of the system, the key no longer corresponding defacto to the “magnetic code” of the cylinder, which securitizes the device against any non-authorized attempt at manceuvre.

According to advantageous but non-obligatory aspects of the invention, the locking device incorporates one or more of the following characteristics:
each bushing is adapted to maintain the two magnets or the magnet provided with at least one bipolar extremity that it clasps in a given angular position with respect to a longitudinal axis of the bushing.
the angular position of the magnet provided with at least one bipolar extremity or of the two magnets clasped in the same bushing is maintained by the fact that the magnets are immobilized in the bushing by the cooperation of at least one member for blocking in rotation located on an outside wall of the bushing adapted to cooperate with a member of complementary shape located on an inside wall of a housing for receiving this same bushing. The blocking member is advantageously a finger, a stud or a slideway. The member of shape complementary to the blocking member is, respectively, a slideway, a finger or a stud.
The bushings and the magnets or the magnet provided with at least one bipolar extremity, are of non-circular section.
The magnet provided with at least one bipolar extremity or the two magnets of inverted polarity, clasped in the same bushing, have magnetic moments of the same intensity and of opposite directions. In a variant, these magnetic moments are of different intensities and of opposite directions.
The bushings located on the cylinder are mobile in translation in housings, while the bushings located on the key are immobile in their housings.
The parts of different polarities of a magnet provided with at least one bipolar extremity or of the magnets clasped in each bushing of the cylinder have magnetic moments of the same intensity and of opposite directions. In a variant, these magnetic moments are of different intensities and of opposite directions.
The magnets of the cylinder and of the key are anisotropic. In a variant, they are isotropic.

The invention also relates to a means for obturating an opening or an access provided with a locking device made in accordance with any one of the above-defined characteristics.

Thanks to the invention, the quality of the relative positioning of the magnets is ensured, this being primordial taking into account the size of such magnets. With such a configuration, one also dispenses with the clearance between the bushing and its housing, this clearance generating a risk of rotation of the bushing in its housing.

The invention will be more readily understood and other advantages thereof will appear more clearly on reading the following description of a form of embodiment of a locking device according to the invention, given solely by way of example and made with reference to the accompanying drawings, in which:

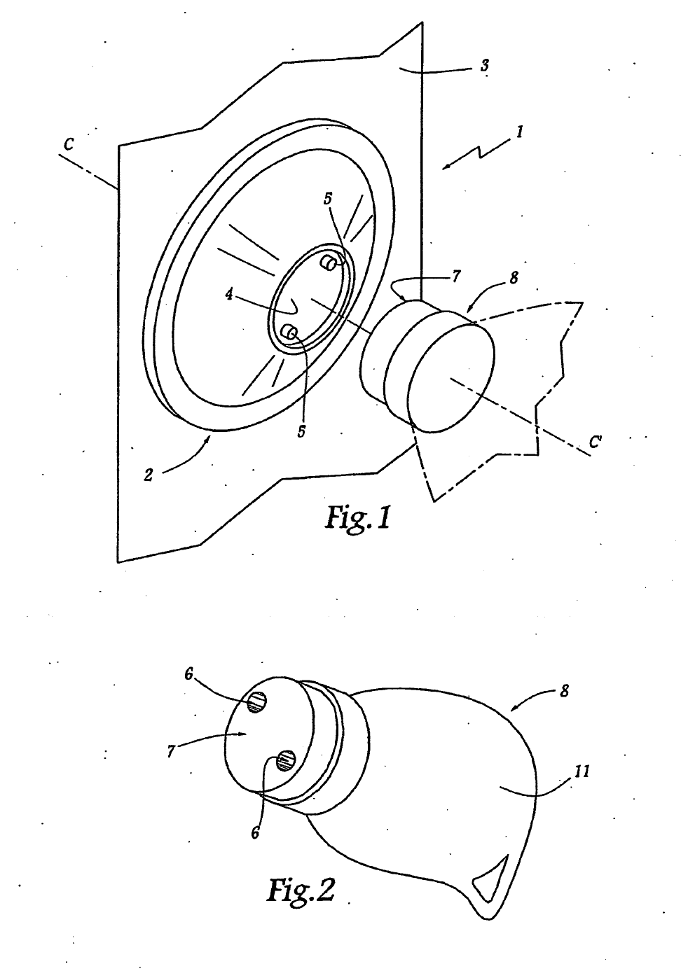

FIG. 1 is a view in perspective of a locking device according to the invention, the cylinder being in place in a partially shown door, the key being represented ready to be engaged in the device.

FIG. 2 is a view in perspective of the key.

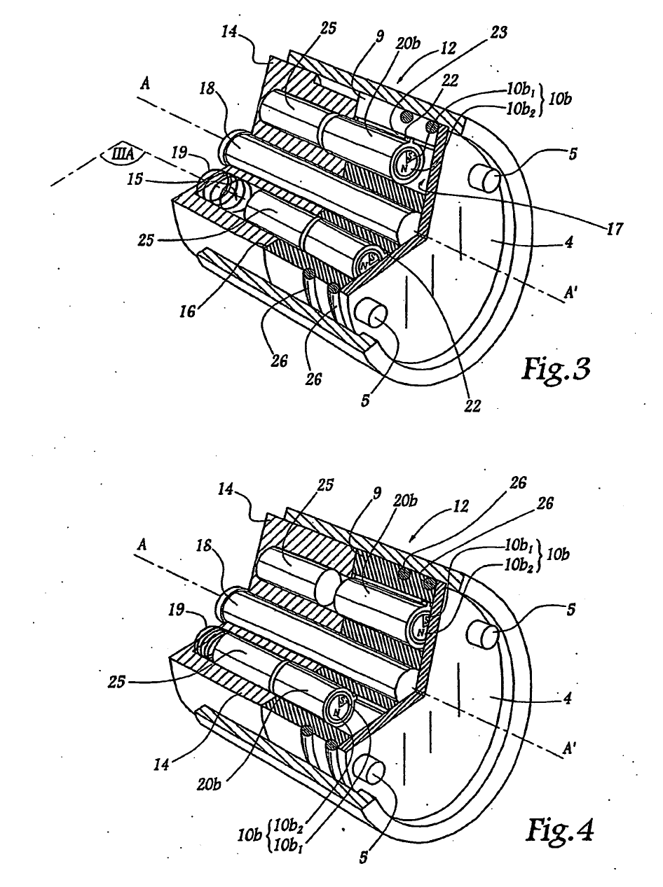

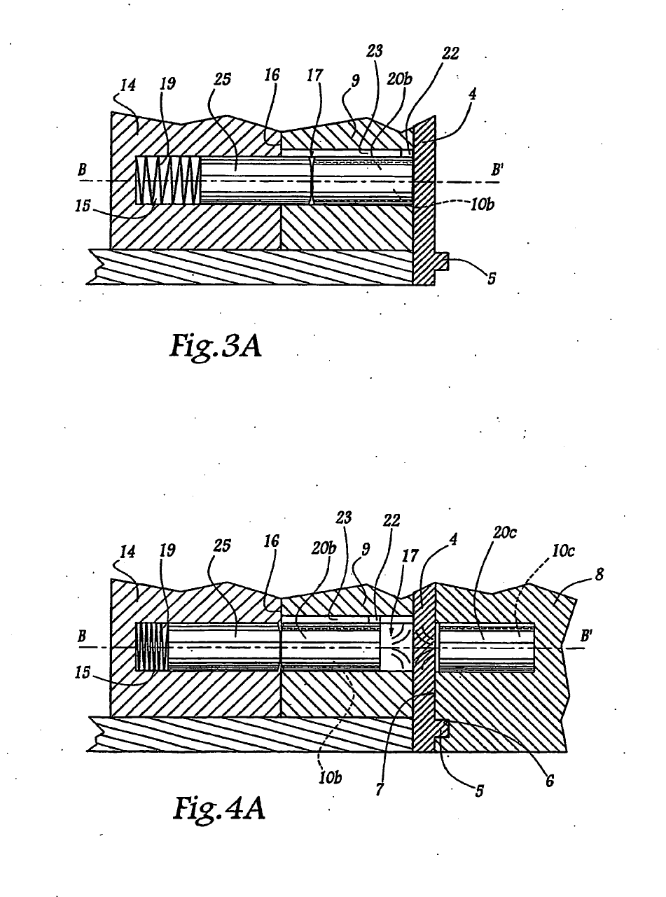

FIG. 3 is a view in perspective, with parts torn away, of a part of the cylinder, the rotor being in locked position.

FIG. 4 is a view similar to FIG. 3 with the rotor in unlocked position.

FIGS. 3A and 4A are schematic partial sections, on a larger scale, along plane IIIA of the device, in locked position without the key and unlocked with the key in place, respectively.

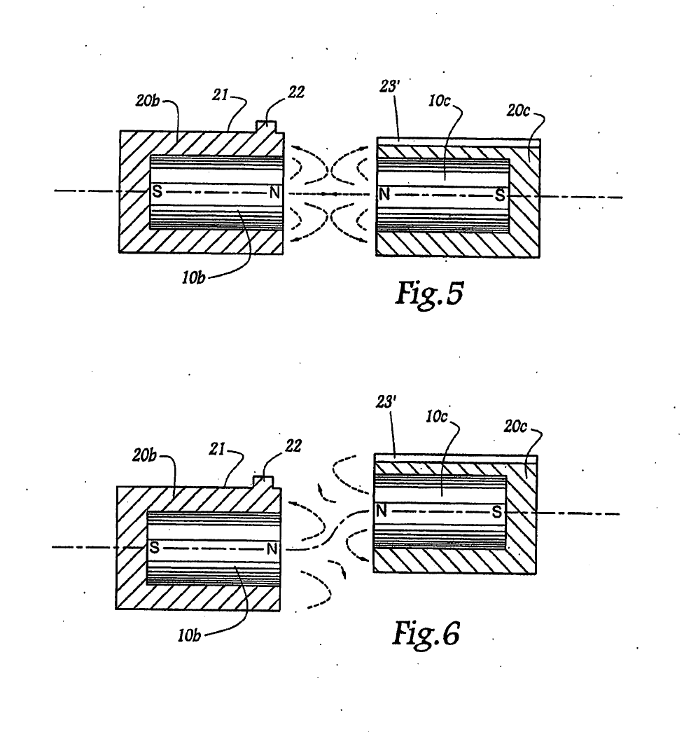

FIGS. 5 and 6 schematically show the different forces of attraction and of repulsion between the magnets borne by bushings located respectively in the key and in the rotor depending on the alignment or non-alignment of their respective magnetic axes.

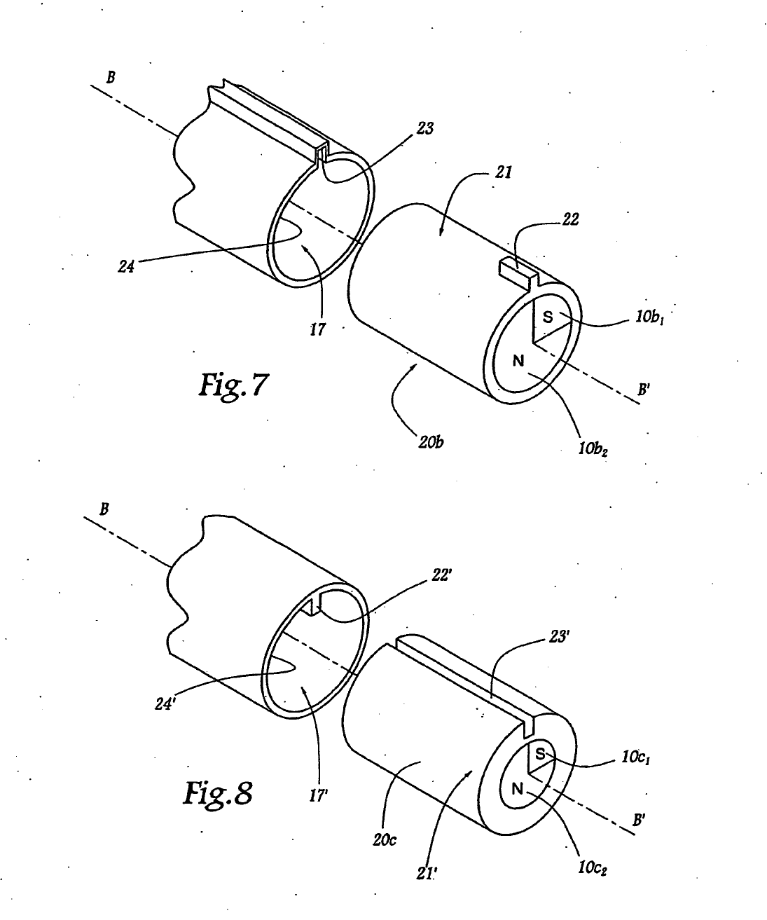

FIGS. 7 and 8 are partial views in perspective illustrating two forms of embodiment of the blockage in rotation of a bushing in its housing.

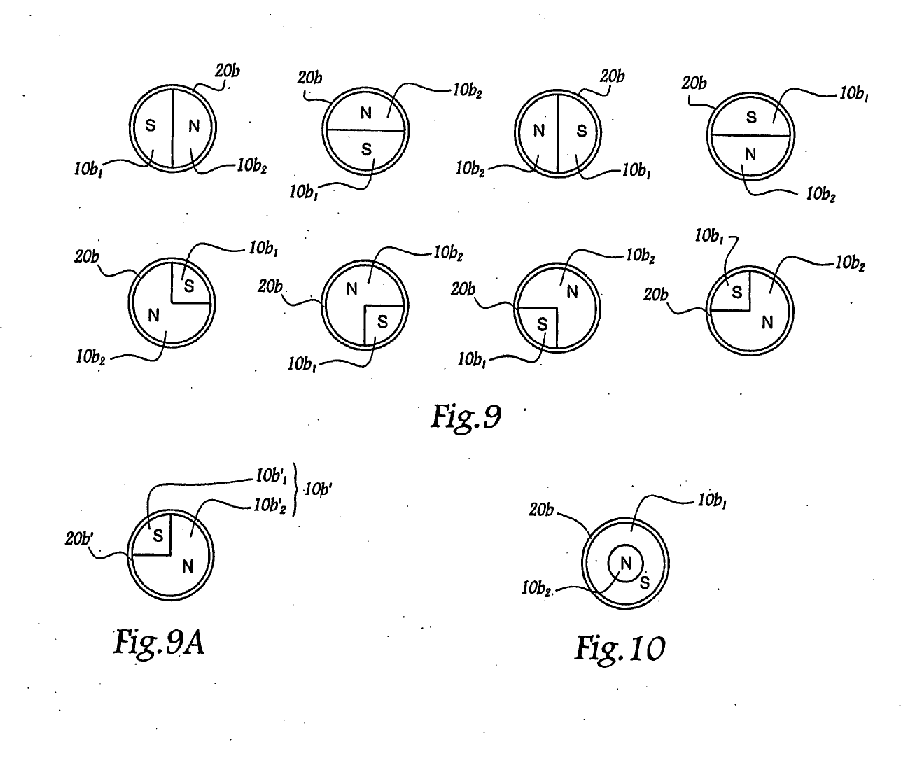

FIG. 9 schematically shows the various possibilities of geometric distribution of the magnets of the cylinder, such distributions being transposable to the key.

FIG. 9A is a view similar to a part of FIG. 9 for a bushing equipped with a single magnet whose extremity is bipolar.

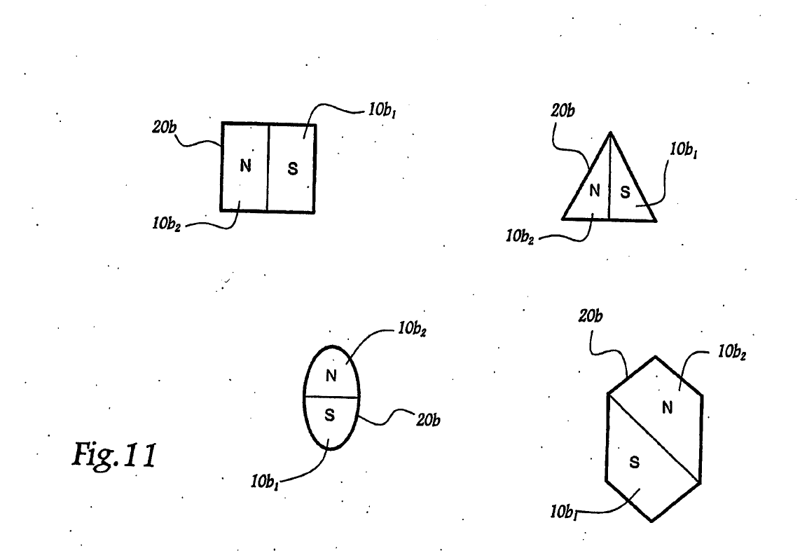

FIG. 10 schematically shows another type of insertion of two magnets of inverted polarity in a bushing, and FIG. 11 schematically shows other possible geometric configurations for the bushings.

The device 1 shown in FIG. 1 comprises a front face 2 apparent on a face 3 of a door. This front face is made of metal, for example steel, and is fitted on the door so as to offer no interstice or clearance that might be used for “forcing” the device 1. The front face 2 is in the form of a dome with circular base of which the apex 4 is truncated. This apex 4 is formed by a plane, smooth, circular plate. It is provided in the vicinity of its periphery with two diametrally opposite studs 5. These studs 5 have the shape of two cylinders of small dimensions of which the longitudinal axis is oriented in a direction globally perpendicular to the plane of the face 3. They present a shape adapted to be inserted in impressions 6 located on a plane face 7 of a key 8. This face 7 is solid, smooth and its shape and dimensions are complementary to those of the apex 4. The introduction of the studs 5 in the impressions 6 makes it possible to position the key on the plate 4 of the device.

The zones 4 and 7 in contact correspond to the outer surfaces of the extremities of the key 8 and of the rotor 9. In this way, contact and cooperation between the part of the device 1 fixed in the door and the part of the key ensuring the mancuvre is effected by the superposition of two smooth, planar surfaces 4 and 7. Behind these surfaces 4 and 7 are located magnets 10b and 10c. These magnets 10b and 10c, in the form of a bar, are disposed so that their magnetic axes are oriented in a direction globally parallel to a central axis CC′ of the apex 4. They are located, both those adjacent the plate 4 and those adjacent the surface 7, so that one of their magnetic poles is in contact with one of these surfaces. The magnets 10b and 10c are geographically distributed in the same manner in the rotor 9 and the key 8 with the result that the magnetic pole of a magnet 10b located in the rotor 9 can act only on the magnetic pole of one sole complementary magnet 10c housed in the key 8.

The body of the key 8 is in the form of a cylinder, visible in FIG. 2, of short length with respect to the diameter of its base. This base is formed by the face 7 of the key bearing the impressions 6. The extremity opposite this face 7 bears a means for gripping the key in the form of a palette 11, shown in FIG. 2.

The locking device 1 comprises in particular a cylinder 12 of hollow cylindrical shape housing a stator 14 provided with a plurality of tubular housings 15, with identical circular bases. The stator 14 is located in a region of the cylinder remote from the plate 4. In this way, the stator 14 is located in that part of the cylinder 12 set in the door. The housings 15 have an open extremity flush with the face 16 of the stator 14 in contact with a rotor 9. The latter has a cylindrical shape similar to that of the stator 14. It is also provided with a series of housings 17 of shapes and diameters identical to the housings 15 of the stator. The housings 17 are made in the rotor so as to extend, over the whole length of the rotor 9, the housings 15 of the stator 14. They are open at their two extremities.

A rotational spindle 18 is positioned in a direction globally merged with the longitudinal and central axis AA′ of the cylinder 12. This spindle 18 is fast with the rotor 9 and mounted to rotate freely in a through orifice made over the length of the stator 14. O-rings 26 located on the outer wall of the rotor ensure seal. The rotor is also provided with a so-called “anti-boring” device (not shown).

The housings 15 each comprise a return spring 19 at the level of their blind extremities located in the stator 14. These housings 15 house bushings 20b in each of which two magnets 10b₁ and 10b₂ are inserted and immobilized for example by gluing. The central longitudinal axis BB′ of these bushings is globally parallel to the axis AA′ of the cylinder. As shown in FIG. 7, the bushings 20b are provided, on the outer radial surface 21 of their wall, with a finger 22. The latter is adapted to be inserted in a groove 23 of complementary shape made in the inner face 24 of the wall of a housing 17 and forming slideway for the finger 22. This groove 23 is made over the whole length of the housing 17 and oriented in a direction globally parallel to axis BB′.

In a variant shown in FIG. 8 which concerns a bushing 20c mounted in the key 8 and clasping two magnets 10c₁ and 10c₂, a finger 22′ is borne by the inner face 24′ of a housing 17′ made in the key 8. In this configuration, it is the outer face 21′ of the wall of the bushing 10c which bears a complementary groove 23′.

In practice, FIGS. 7 and 8 may concern the bushings 20b and 20c equally well.

For the bushings 20c shown in FIG. 8, the grooves 23′ ensure only the blocking of the fingers 22′ in rotation and do not have the function of forming a slideway for a bushing 20c. The latter are immobilized in their housings 17′.

Two magnets 10b₁ and 10b₂ of inverted polarities and preferably anisotropic, i.e. being able to be magnetized only in a preferential direction, are clasped in each bushing 20b. As shown in the upper part of FIG. 9, these two magnets 10b₁, and 10b₂ may be in the form of two half-cylinders of the same dimensions. In the same bushing 20b, there may also be one magnet 10b₂ representing, in cross section, three-quarters of a disc and another magnet 10b₁ representing a quarter of a disc as is visible in FIGS. 3, 4, 7, 8, 9A and in the lower part of FIG. 9. These two configurations may be presented simultaneously and in any proportions and distribution in the same locking device 1.

In the same way, a bushing 20c bears two magnets 10c₁ and 10c₂ which may be in the form of two identical half-cylinders or a magnet 10c₂ representing in cross section three quarters of a disc, the other magnet 10c₁ forming a quarter of a disc.

The precise positioning of a bushing 10b in its housing, thanks to the finger 22 and to the groove 23, makes it possible to “pair off” the magnets 10b₁ and 10b₂ of the rotor 9 and those 10c₁ and 10c₂ of the key 8, in one of the different positions shown in FIG. 9. As shown in FIG. 9A, a single magnet 10b′ may be immobilized in a bushing 20b′ of the cylinder. This magnet 10b′ is bipolar at least at the level of its extremity turned towards the front face 2. Similarly, magnets of which one face is bipolar may be provided in the bushings 10c of the key 8. The two zones 10b′₁ and 10b′₂ of inverted polarity of the extremity of the magnet 10b′ visible in FIG. 9A perform a role similar to the one envisaged hereinabove for the magnets 10b₁ and 10b₂.

In another form of embodiment shown in FIG. 10, magnets 10b₁, 10b₂ or 10c₁, 10c₂ are in the form of two concentric cylinders, one, hollow, forming a peripheral magnet of polarity inverse of the solid one forming a central magnet. In this case, the means for angularly positioning the magnets are not indispensable.

In another form of embodiment shown in FIG. 11, the bushings 10b, 10c present a non-circular cross section. This section is for example rectangular, triangular, polygonal or oval. With such shapes of bushings, there is no more need for a means for blocking in rotation when these bushings are positioned in their respective housings.

The magnets 10b₁, 10b₂, 10c₁ and 10c₂ act in repulsion or in attraction depending on their alignments, their angular positions and their polarities. In position of rest, shown in FIG. 3A, a return spring 19 located in the closed end of a housing 15 pushes a piston 25 which displaces the magnets 10b, and 10b₂ of the rotor 9 towards the opening of the housings 17.

This piston 25 is positioned in the housing 15 between the spring 19 and the bushing 20b. The length of the piston 25 is adapted to the return force of the spring 19 inserted in a given housing 15.

In fact, these pistons 25 displace the bushings 20b located in the housings 17 so that said bushings come, at the end of stroke, in contact with the surface 4 of the device 1. In this configuration, the pistons 25 are positioned both in part in the housings 17 of the rotor 9 and in part in the housings 15 of the stator 14. They then block the rotor 9 in rotation.

Certain housings 15, visible in FIGS. 3 and 4, do not house any spring 19. In that case, the piston 25 forms a member for translatory abutment for the movement of a bushing 20b moving in the housing 17 towards the housing 15 located in its extension. The displacement of the bushing 20b is induced by the attraction of a magnetic pole of the magnet 10b₁ or 10b₂, immobilized in the bushing 20b, by the metallic end of the piston. The length of the piston 25 is adapted so that, when the bushing 20b is in abutment on the piston 25, it straddles the zone of join between the stator 14 and the rotor 9.

In this position, the pistons 25 and/or the bushings 20b make it possible to block the rotor 9 in rotation. In this way, the device remains locked.

When the key 8 is presented opposite the plate 4, care being taken to insert the studs 5 in the impressions 6, there is register between the magnets 10b₁, 10b₂, 10c₁ and 10c₂ of the rotor 9 and of the key 8 located on either side of the plate 4 and the face 7. As shown in FIGS. 4 and 4A, depending on their polarity, the magnets 10c₁, 10c₂ of the key 8 repel or attract the magnets 10b₁, 10b₂ set in the bushings 20b. In this way, the pistons 25 are disengaged from the zone of join between the stator 14 and the rotor 9. Disengagement is obtained, in that case, by compression of the springs 19 under the action of the pistons 25 pushed back in the direction of the bottom of the housings 15 by the bushings 20b.

In the second case of bushings 20b being located opposite the housings 15 having no spring 19, these bushings 20b are attracted in the direction of the plate 4 by the magnets 10c₁, and 10c₂ of the key 8 and are totally housed in the housings 17 of the rotor 9.

In this way, the rotor 9 is unblocked in rotation and this movement, generated by the key 8 on the rotor 9, also makes it possible to rotate the spindle 18, and therefore the system of linkage with the keeper and the bolt of the door, in order to be able to open the latter.

With such a device, it is easy to multiply the number of possible combinations by playing on the angular position of the magnets and/or the intensity of the magnetic moments as well as on the lengths of the pistons 25 and the springs 19.

For example, for a cylinder 12 and a key 8 of which the surfaces 4 and 7 each have a diameter of about 15 millimetres, a geographical distribution of six bushings 20b, 20b′, 20c with a unitary diameter of 3 millimetres can be imagined. By playing on the intensity of the magnetic moment and on the angular position of each bushing 20b, 20b′, 20c, possible associations of polarity of the magnets 10b₁, 10b₂, 10b′₁ and 10b′₂ of the rotor 9 and of the magnets 10c₁ and 10c₂ of the key 8, greater than twenty million, are attained.

The invention has been described with reference to forms of embodiment where all the bushings clasp and maintain two magnets. It may in fact be that only certain bushings clasp and maintain two magnets.

In another configuration, the magnets do not occupy all the interior volume of a bushing 20b, 20b′ or 20c. The remaining volume may be filled with an a magnetic or ferromagnetic material.

In another form of embodiment, the displacement of the rotor is no longer effected in rotation about the longitudinal axis AA′ of the cylinder, but in translation in a direction globally perpendicular to axis AA′.

1. Magnetically controlled locking device (1) comprising a cylinder (12) associated with a key (8), said cylinder (12) being provided with a stator (14) and a rotor (9), said rotor being adapted to be rotated about a longitudinal axis (AA′) of the cylinder thanks to a key (8), the latter being equipped with magnets 10c) clasped in bushings (20c) made of ferromagnetic material and adapted to cooperate with other magnets (10b, 10b′) likewise clasped in bushings (20b, 20b′) made of ferromagnetic material, mounted to slide in at least a part of said cylinder (12) so as to be able selectively to lock the rotation of said rotor (9), these magnets (10c, 10b, 10b′), respectively borne by said key (8) and said cylinder (12), being of the same geographical distribution, characterized in that at least two bushings (20c, 20b, 20b′), located respectively in said key (8) and said cylinder (12), each clasp and maintain two magnets (10c₁, 10c₂, 10b₁, 10b₂) of inverted polarity (N-S) with respect to each other or a magnet (10b′) provided with at least one bipolar extremity in a given angular position with respect to a longitudinal axis (BB′) of said bushing.

2. Locking device according to claim 1, characterized in that the maintaining of the angular position of the magnet (10b′) provided with at least one bipolar extremity or of the two magnets (10b₁, 10b₂, 10c₁, 10c₂) clasped in the same bushing (20b, 20b′, 20c) is obtained by the fact that said magnets are immobilized in said bushing by the cooperation of at least one member (22, 23′) for blocking in rotation located on an outside wall (21, 21′) of said bushing (20b, 20b′, 20c) adapted to cooperate with a member (23, 22′) of complementary shape located on an inside wall (24, 24′) of a housing for receiving (17, 17′) this same bushing.

3. Locking device according to claim 2, characterized in that said blocking member is a finger (22), a stud or a slideway (23′).

4. Locking device according to claim 2, characterized in that said member of shape complementary to the blocking member is, respectively, a slideway (23), a finger (22) or a stud.

5. Locking device according to claim 1, characterized in that said bushings (20b, 20b′, 20c) and said magnets (10b, 10c) or the magnet (10b′) provided with at least one bipolar extremity, are of non-circular section.

6. Locking device according to claim 1, characterized in that the magnet (10b′) provided with at least one bipolar extremity or said two magnets (10b₁, 10b₂, 10c₁, 10c₂) of inverted polarity, clasped in the same bushing (20b, 20b′, 20c), have magnetic moments of the same intensity and of opposite directions.

7. Locking device according to claim 1, characterized in that the magnet (10b′) provided with at least one bipolar extremity or said two magnets (10b₁, 10b₂, 10c₁, 10c₂) of inverted polarity, clasped in the same bushing (20b, 20b′, 20c), have magnetic moments of different intensities and of opposite directions.

8. Locking device according to claim 1, characterized in that said bushings (20b, 20b′) located on said cylinder (12) are mobile in translation in housings (15, 17), while said bushings (20c) located on said key (8) are immobile in their housings.

9. Locking device according to claim 1, characterized in that the parts (10b′₁, 10b′₂) of different polarities of a magnet (10b′) provided with at least one bipolar extremity or of the magnets (10b₁, 10b₂) clasped in each bushing (20b, 10b′) of the cylinder (12) have magnetic moments of the same intensity and of opposite direction.

10. Locking device according to claim 1, characterized in that the parts (10b′₁, 10b′₂) of different polarities of a magnet (10b′) provided with at least one bipolar extremity or of the magnets (10b₁, 10b₂) clasped in each bushing (20b, 10b′) of the cylinder (12) have magnetic moments of different intensities and of opposite direction.

11. Locking device according to claim 1, characterized in that said magnets of said cylinder (12) and of said key (8) are anisotropic.

12. Locking device according to claim 1, characterized in that said magnets of said cylinder (12) and of said key (8) are isotropic.

13. Means for obturating an opening or an access provided with a locking device (1) according to claim 1, and with an associated key (8).
